(19) United States
(12) Patent Application Publication
(10) Pub. No.: US 2009/0003226 A1
(43) Pub. Date: Jan. 1, 2009

(54) Network intermediary device with connection test packets

(75) Inventors: Chih-Jung Wang, Taipei Hsien (TW); Ming-Chung Chen, Taipei Hsien (TW)

Correspondence Address: BIRCH STEWART KOLASCH & BIRCH, PO BOX 747, FALLS CHURCH, VA, 22040-0747, US

(73) Assignee: MOXA NETWORKING CO., LTD

(21) Appl. No.: 11/819,982

(22) Filed: Jun. 29, 2007

(51) Int. Cl. G06F 11/00

(52) U.S. Cl. 370/251

(57) ABSTRACT

A network intermediary device which determines the connection status with remote network intermediary devices by means of generating continuously connection test packets at same or different time intervals. When one remote network intermediary device does not receive the connection test packets within a predetermined timeout interval or has received fragged or damaged packets, the connection between the local network intermediary device and the remote network intermediary device is determined to be abnormal.

### BACKGROUND OF THE INVENTION

1. Field of the Invention

The present invention relates to a network intermediary device having media access controls (MAC) and physical layer (PHY) circuitries and more particularly, to a network intermediary device having a connection test sender and receiver, which will send connection test packets to other remote network intermediary devices so that local and remote network intermediary devices can detect the connection status of multiple network intermediary devices through the connection test packets.

2. Description of the Related Art

Following fast progression of communication technology, the related communication networks are well developed. LAN (Local Area Network) and WAN (Wide Area Network) are the original categories of networks categorized subject to their scope and scale. A LAN connects network devices over a relatively short distance. A WAN is a geographically-dispersed collection of LANs. The Internet is the largest WAN, spanning the Earth.

Either in LAN or WAN, Ethernet has proven itself as a relatively inexpensive, reasonably fast, and very popular LAN technology. Ethernet cables (fiber optics or twisted pair) are limited in their reach, and these distances are insufficient to cover medium-sized and large network installations. Therefore, repeaters are used in Ethernets. A repeater in Ethernet networking is a device that allows multiple cables to be joined and greater distances to be spanned. A bridge device can join an Ethernet to another network of a different type, such as a wireless network. Popular types of repeater devices are Ethernet hubs, switches and routers. By means of the combination of Ethernet cables with hubs, switches and/or routers, an Ethernet networking allows transmission or control of data or instructions among different LANs, computers, and/or other devices such as surveillance systems, security systems, automation systems, etc.

In order to conform to the network protocols defined by the seven-layer architecture of OSI (Open System Interconnection), all kinds of the network intermediary devices are required to be built in with the physical layer circuit (called, “PHY”) and the media access control circuit (called, “MAC”). In general, such physical layer means the connection ports and transmission lines defined within the specification of network intermediary devices.

Because the physical layer is in charge of sending or receiving physical signals, the physical layer circuitries of ordinary communication network devices have the function of detecting the connection status between Local and Remote and notice the users of the detection result by means of LED indicator lights therein. Because such the detection is done only by the physical layer circuitries, even though the PHYs have detected the status of connection between the two sides to be normal, it does not mean the MACs of the two communication network devices at the two sides are ready to receive or to send data packets.

As multiple connections and data transmission among network intermediary devices go on, each respective MAC not only transforms the respective data into packets and forwards the packets but also checks the received packets to see any packet loss. Therefore, the MAC can process some easy test to the transmission line between the network intermediary devices, then as the remote sending network intermediary device uses its MAC to transform data into the form of packets, the packets will be sent by the PHY to the transmission line, which will then sends the packets to the network intermediary device at the remote site. Upon receipt of the packets by the network intermediary device at the remote site, the PHY of the network intermediary device sends the packets to the MAC, and the MAC will check the packets. If the packet checked to be no error, the MAC will fetch the data from the packets and confirm whether or not the data are for the connection test. When the data within the packets conformed to be for the connection test, we can say that the transmission between the sender of the remote network intermediary device and the receiver of the local network intermediary device is normal. On the contrary, the transmission status between the sender of the local network intermediary device and the receiver of the remote network intermediate device can be checked in the same manner. At final, if the MAC detected any abnormalities in the transmission line, the LED indicator lights of the network intermediary device or network management software will indicate the abnormal status of the transmission line.

Although the aforesaid network intermediary devices and packets transmission approach has been used for many years, it still has numerous drawbacks as follows:

1. Regular multiple-connection network intermediary devices are interconnected by transmission lines, but such network intermediary device use their own private MAC to perform packets transmissions. Therefore, as a remote network intermediary device has perceived fragged or damaged packets, the only way to do besides giving up the fragged or damaged packets is to connect the sending side network intermediary device. The remote network intermediary device will not notify the user of the network intermediary device or the network administrator until massive packets destructions or fragmentations have occurred to develop a serious abnormality in the transmission line, and therefore examination and error correction of irregularities of the network intermediary devices or transmission line cannot be done at the very beginning. For example, in a regular industrial production line (such as wafer plant, plastic materials plant) or security system (such as building surveillance system), if the abnormal status of the transmission line cannot be forwarded to the user or network administrator immediately, the industrial production line or security system will keep working until interruption of the transmission line or occurrence of extremely serious abnormalities. When this happens, the local user or network administrator will not be able to control the remote industrial production line or security system, thereby resulting in paralysis or damage of the machinery of the industrial production line, or a blind spot of the security system.

2. Furthermore, although some network intermediary devices can test the connection status, the test basically uses PHY to send a connection-detection signal and then the remote network intermediary device judges if there is any abnormality in the transmission line. But as the PHY detected the connection between the local site and the remote side is normal, it does not mean that the MACs of the local and remote network intermediary devices can transmit/receive data packets normally. Accordingly, if a network intermediary device simply uses its PHY to determine the connection status between the local site and the remote side, it will not be able to determine whether or not the remote network intermediary device can receive the data normally. In this case, the network administrator or surveillance system cannot correctly judge the connection status between the local network intermediary device and the remote network intermediary device, causing serious consequences.

Therefore, it is desirable to provide a network intermediary device that eliminates the aforesaid problems.

### SUMMARY OF THE INVENTION

The present invention has been accomplished under the circumstances in view. According to one aspect of the present invention, during data transmission between a local network intermediary device and a remote network intermediary device, the built-in connection test sender and receiver device of the local (or remote) network intermediary device generates connection test packets and sends the generated connection test packets to the remote (or local) network intermediary device, and the connection status is judged to be normal or abnormal subject to the receiving status of the connection test packets by the remote (or local) network intermediary device after a predetermined timeout interval. Thus, the surveillance system or network administrator can accurately judge whether the PHY of the network intermediary device at one side (the local site or remote site) has only the connection signal but cannot send data to the network intermediary device of the other side (the remote site or local site).

It is another object of the present invention to provide an intermediary device that saves much the time in connection test. When shortening the time interval in generating connection test packets, the detection of a network connection failure according to the present invention will be much faster than the conventional method utilizing the link signals of the PHY to detect the connection.

### BRIEF DESCRIPTION OF THE DRAWINGS

FIG. 1 is a system block diagram of a first embodiment of the present invention.

FIG. 2 is a network intermediary device connection test flow chart according to the present invention.

FIG. 3 is a system block diagram of a second embodiment of the present invention.

FIG. 4 is a system block diagram of a third embodiment of the present invention.

### DETAILED DESCRIPTION OF THE PREFERRED EMBODIMENT

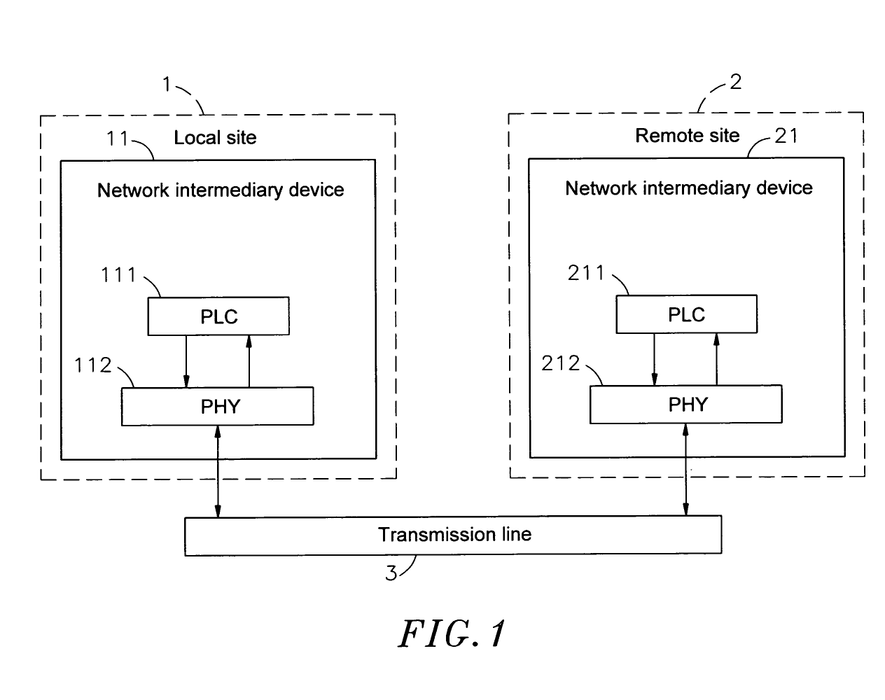

Referring to FIG. 1, a network intermediary device 11 at the local site 1 is connected to a network intermediary device 21 at the remote site 2 through a transmission line 3.

The network intermediary device 11 mainly comprises a programmable logic controller (PLC) 111 and a physical layer circuit (PHY) 112.

The programmable logic controller 111 generates and receives connection test packets, and judges the status of the connection test packets sent by the network intermediary device 11 at the local site 1 and the network intermediary device 11 at the remote site 2.

The PHY 112 is electrically connected to the programmable logic controller 111, and can receive connection test packets from the programmable logic controller 111 and transmit received connection test packets to the remote network intermediary device 21. The PHY 112 has a connection port for the connection of the transmission line 3. To fit the connection port of the PHY 112, the transmission line 3 can be optical fiber, twisted-pair or coaxial cable.

To avoid misunderstanding, the programmable logic controller 111 indicated in the specification means a connection-test sender and receiver device. According to this embodiment, the term of programmable logic controller is used to substitute for the connection-test sender and receiver device. Alternatively, the connection-test sender and receiver device can be a Programmable Logic Devices (PLD), Field Programmable Gate Array (FPGA), CPU or μP that has logic computation functions.

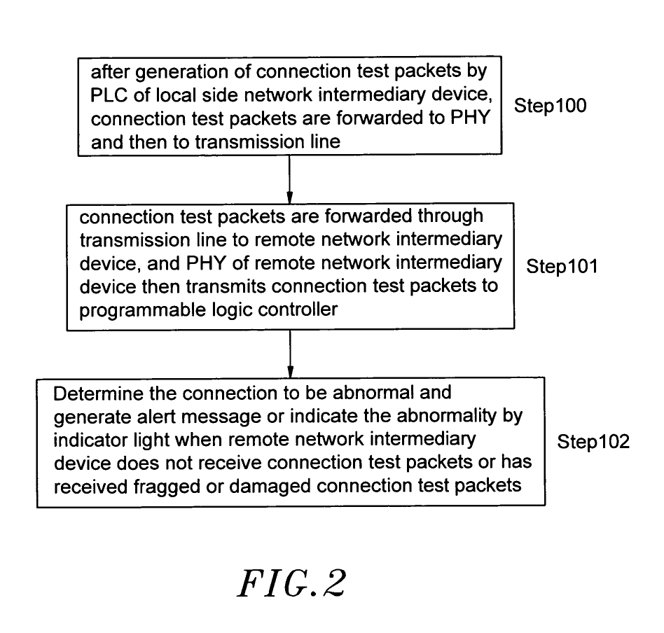

Referring to FIG. 2 and FIG. 1 again, same as the network intermediary device 11 at the local site 1, the network intermediary device 21 at the remote side 2 is comprised of a programmable logic controller (PLC) 211 and a physical layer circuit (PHY) 212. As illustrated, after linking of the network intermediary devices 11 and 21 through the transmission line 3 to form an electrical connection, the following steps are executed to make a network connection test by packets:
(100) After generation of connection test packets, the programmable logic controller 111 of the local network intermediary device 11 forwards the generated connection test packets to the associating PHY 112 and the transmission line 3;
(101) The connection test packets are forwarded through transmission line 3 to the remote network intermediary device 21, and the PHY 212 of the remote network intermediary device 21 then sends the connection test packets to the associating programmable logic controller 211;
(102) Determine the connection between the local network intermediary device 11 and the remote network intermediary device 21 to be abnormal and then generate an alert message or drive on an indicator light to give an alert indication if the remote network intermediary device 21 does not receive the connection test packets within a predetermined timeout interval or the remote network intermediary device 21 has received fragged or damaged packets.

During execution of the aforesaid steps, the local network intermediary device 11 and the remote network intermediary device 21 are respectively connected to the transmission line 3 with the respective PHYs 112 and 212 for data transmission therebetween. Under data transmission, the programmable logic controller 111 of the local network intermediary device 11 generates connection test packets and sends them to the associating PHY 112, which then transmits the connection test packets to the PHY 212 of the remote network intermediary device 21 through the transmission line 3. Upon receipt of the connection test packets, the PHY 212 of the remote network intermediary device 21 sends the received connection test packets to the associating programmable logic controller 211. However, if the remote network intermediary device 21 dose not receive the connection test packets within a predetermined timeout interval or the received connection test packets are fragged or damaged, the transmission path, connection or data transmission status between the local network intermediary device 11 and the remote network intermediary device 21 is determined to be abnormal. Further, the programmable logic controller 211 of the network intermediary device 21 at the remote site 2 can also generate network test packets and send the generated network test packets to the network intermediary device 11 at the local site 1 through the associating PHY 212 via the transmission line 3, so that the condition of the transmission path, connection or data transmission status between the remote network intermediary device 21 and the local network intermediary device 11 can be determined in the same manner. Further, when if transmission line 3 or the network intermediary device 21 at the remote site 2 is determined to be abnormal, the programmable logic controller 111 of the local network intermediary device 11 will generate an alert message and send the alert message to other network intermediary devices at the remote site through another transmission line so that the informed remote network intermediary devices know which network intermediary device is in trouble. In addition to generating an alert message, the programmable logic controller 111 of the local network intermediary device 11 is capable to calling or waking up the other network intermediary devices at the other remote sites.

Further, under the framework of the present invention, one network intermediary device can simultaneously forward multiple network connection test packets to many other network intermediary devices or receive multiple network connection test packets from many other network intermediary devices. Accordingly, in a big scale network system, one network intermediary device can test its connection with other network intermediary devices, and can also test the connection with other electronic devices (personal computer, surveillance systems, security systems, etc) in the same manner.

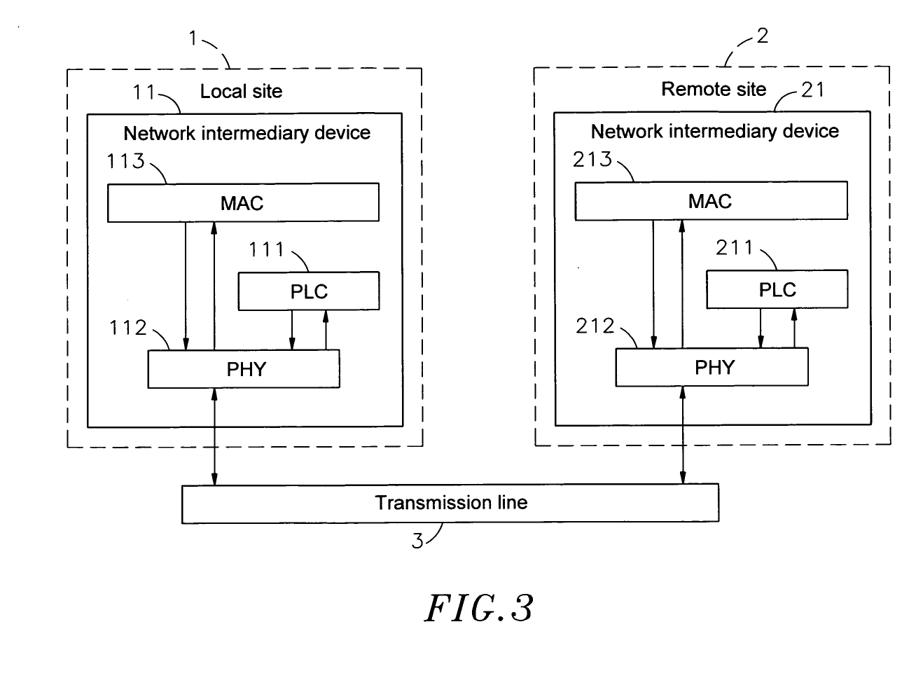

FIG. 3 is a circuit block diagram of a second embodiment of the present invention. This embodiment is substantially similar to the aforesaid first embodiment with the exception of the additional media access control circuit (MAC). As illustrated, each network intermediary device 11 or 21 comprises a media access control circuit (MAC) 113, which is compatible to the OSI (Open Systems Interconnection) architecture and, can transmit the network connection test packets generated by the associating programmable logic controller 111 or 211 through the associating PHY 112 or 212. Thus, when the local network intermediary device 11 is in data transmission with the remote network intermediary device 21, the programmable logic controller 111 of the network intermediary device 11 generates connection test packets. The test packets are combined with the data transmitted by the MAC 113 to form data packets format that fits the OSI architecture. The OSI format data packets thus obtained are then sent outwards by the PHY 112 of the local network intermediary device 11 through the transmission line 3. Upon receipt of the OSI format data packets by the remote network intermediary device 21, the programmable logic controller 211 of the network intermediary device 21 will process the OSI format data packets. However, if the remote network intermediary device 21 does not receive the OSI format data packets within a predetermined timeout interval or the remote network intermediary device 21 received fragged or damaged OSI format data packets packets, the transmission path, connection or data transmission status between the local network intermediary device 11 and the remote network intermediary device 21 will be determined to be abnormal. In the same way, the connection test packets generated by the network intermediary device 21 can be combined into the data to be transmitted to form data packets format that fits the OSI architecture, the OSI format data packets thus obtained will be then transmitted to the local network intermediary device 11 through the transmission line 3 for testing the connection status between the remote network intermediary device 21 and the local network intermediary device 11. If the connection between the remote network intermediary device 21 and the local network intermediary device 11 is examined to be abnormal, the programmable logic controller 111 of the local network intermediary device 11 will generate an alert message, informing the user or network administrator of the abnormal status so that the party concern can fix the problem at the very beginning.

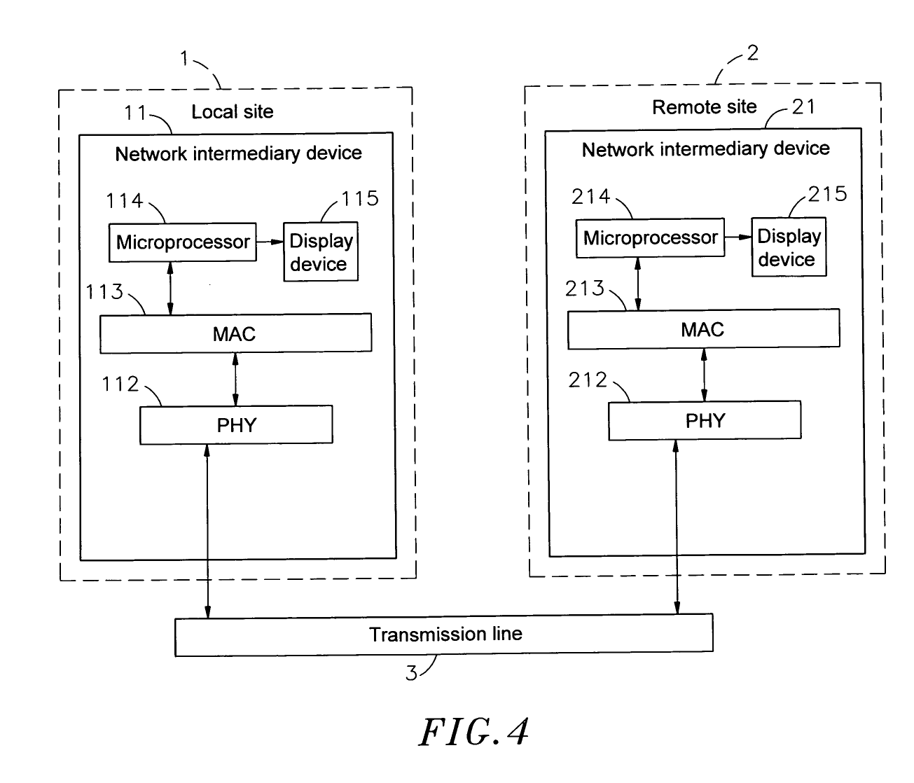

FIG. 4 is a circuit block diagram of a third embodiment of the present invention. According to this embodiment, the network intermediary device 11 or 21 comprises a PHY 112 or 212, a MAC 113 or 213, a microprocessor 114 or 214, and a display device 115 or 215. The microprocessor 114 or 214 is capable of generating and receiving connection test packets. The microprocessor 114 or 214 is electrically connected to the associating MAC 113 or 213 and PHY 113 or 213. During data transmission between the local network intermediary device 11 and the remote network intermediary device 21, the microprocessor 114 of the local network intermediary device 11 generates connection test packets and has the generated connection test packets be combined into the data to be transmitted by the associating MAC 113 to form OSI format data packets, enabling the OSI format data packets to be transmitted outwards by the PHY 112 of the local network intermediary device 11 through the transmission line 3. However, if the remote network intermediary device 21 does not receive the OSI format data packets within a predetermined timeout interval or the remote network intermediary device 21 receives fragged or damaged OSI format data packets, the transmission path, connection or data transmission status between the local network intermediary device 11 and the remote network intermediary device 21 is determined to be abnormal.

Referring to FIG. 4 again, the display device 115 or 215 is adapted to indicate the detected connection status between the local network intermediary device 11 and the remote network intermediary device 21 through texts, light signals, numerical or graphic bars, i.e., the display device 115 or 215 can be any kind of display means capable of indicating the detected connection status between the local network intermediary device 11 and the remote network intermediary device 21. Furthermore, the network intermediary device 11 or 21 can be a switch, routers, or any of a variety of other network intermediary devices with the capability of utilizing network connection test packets.

In conclusion, the technical features of the present invention that improve the prior art designs are as follows:

1. Either the network intermediary device 11 at the local site 1 or the network intermediary device 21 at the remote site 2 is in data transmission, the programmable logic controller 111 or 211 or the microprocessors 114 or 214 can send or receive connection test packets and detect the transmission status of the connection test packets, and then determine the connection status of the transmission line 3 and the target network intermediary device 21 or 11 a predetermined timeout interval after transmission of the connection test packets.

This detection method eliminates the drawback of the prior art design in which the MACs at the two opposite sites may still cannot receive or dispatch data packets when the connection between the PHYs of the local and remote network intermediary devices are detected to be normal.

By means of the sending and receiving of the connection test packets between the network intermediary device at the local site and the network intermediary device at the remote site, the network administrator or surveillance system can detect any normality of the transmission line or the connected network intermediary devices. In case of an abnormality of the transmission line or the network intermediary device at the local or remote site, the necessary repair work can quickly be done at the very beginning. Further, if the transmission network has linked thereto an industrial production equipment or security system, the user or network administrator, upon detection of an abnormality of the transmission line 3 or either network intermediary device 11 or 21, can inform the person at the job site or the related technician to repair or maintain the network system, or wake up another network intermediary device at another remote site through the network intermediary device 11 or 21 so as to change the data transmission path. Therefore, the invention prevents the problem that the local user or network administrator is unable to access to or control the remote terminal upon interruption or failure of the transmission line 3 or one of the network intermediary devices 11 and 21.

2. The network intermediary device 11 or 21 can utilize the respective programmable logic controller 111 or 211 or the microprocessor 114 or 214 to generate connection test packets, eliminating the unstable reaction time of the prior art method of using the PHYs to detect the connection status. By means of the programmable logic controller or microprocessors upper to generate connection test packets for detecting the connection status between network intermediary devices, the present invention eliminates the problem of the prior art PHY detection method that cannot check any packet loss or damage.

3. By means of the display apparatus and within the network intermediary devices, users or network administrators can clearly understand or browse the transmission paths, connection or data transmission status of the network intermediary devices, hereby, users or administrators are unnecessary to install additional application programs to monitor the connection status of each network intermediary devices. As network administrators maintain such network intermediary devices, they can focus on irregular light signals or numerical data to do confirmation or maintenance processes.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A network intermediary device linked to remote network intermediary devices through transmission lines and capable of detecting the connection status of the linked transmission lines and remote network intermediary devices by means of connection test packets, the network intermediary device comprising:
a connection test sender and receiver device adapted to generate connection test packets, to send generated connection test packets to said remote network intermediary devices through said transmission lines, to receive connection test packets from said remote network intermediary devices through said transmission lines, and to determine the transmission and receiving status of the connection test packets;
a media access control circuit electrically connects to said connection test sender and receiver device, said media access control circuit being capable of combining the connection test packets generated by said connection test sender and receiver device into a data to be transmitted said media access control circuit so as to form a data packet subject to the OSI (Open Systems Interconnection) architecture; and
a physical layer circuit electrically connected to said media access control circuit, said physical layer being capable of receiving the data packet combined by media access control circuit and transmitting the data packet to said remote network intermediary devices through said transmission lines.

2. The network intermediary device as claimed in claim 1, which is a switch.

3. The network intermediary device as claimed in claim 1, which is a router.

4. The network intermediary device as claimed in claim 1, which is connectable to personal computers and surveillance systems to perform a connection test.

5. The network intermediary device as claimed in claim 1, further comprising a display device adapted to indicate the connection and data transmission status by means of one of the ways of texts, light signals, numerical bars and graphic bars.

6. The network intermediary device as claimed in claim 1, which sends multiple connection test packets to said remote network intermediary devices through said transmission lines at a same time, and receives multiple connection test packets from said remote network intermediary devices through said transmission lines at a same time.

7. The network intermediary device as claimed in claim 1, which is capable of waking up said remote network intermediary devices.

8. The network intermediary device as claimed in claim 1, wherein said connection test sender and receiver device is one of the devices of programmable logic device, field programmable gate array, CPU and UP having logic computation functions.

9. The network intermediary device as claimed in claim 1, wherein said connection test sender and receiver device is directly electrically connected with said physical layer circuit.

10. The network intermediary device as claimed in claim 1, said physical layer circuit is electrically connected with a programmable logic device.

11. A network intermediary device linked to remote network intermediary devices through transmission lines and capable of detecting the connection status of the linked transmission lines and remote network intermediary devices by means of connection test packets, the network intermediary device comprising:
a connection test sender and receiver device adapted to generate connection test packets, to send connection test packets to said remote network intermediary devices through said transmission lines, to receive connection test packets from said remote network intermediary devices through said transmission lines, and to determine the transmission and receiving status of the connection test packets; and
a physical layer circuit electrically connected to said connection test sender and receiver device, said physical layer being capable of receiving the connection test packets generated by said connection test sender and receiver device and transmitting the connection test packets to said remote network intermediary devices through said transmission lines.

12. The network intermediary device as claimed in claim 11, which is a switch.

13. The network intermediary device as claimed in claim 11, which is a router.

14. The network intermediary device as claimed in claim 11, which is connectable to personal computers and surveillance systems to perform a connection test.

15. The network intermediary device as claimed in claim 11, further comprising a display device adapted to indicate the connection and transmission status by means of one of the ways of texts, light signals, numerical bars and graphic bars.

16. The network intermediary device as claimed in claim 11, which sends multiple connection test packets to said remote network intermediary devices through said transmission lines at a same time, and receives multiple connection test packets from said remote network intermediary devices through said transmission lines at a same time.

17. The network intermediary device as claimed in claim 11, which is capable of waking up said remote network intermediary devices.

18. The network intermediary device as claimed in claim 11, wherein said connection test sender and receiver device is one of the devices of programmable logic device, field programmable gate array, CPU and μP having logic computation functions.
